(19) United States
(12) Patent Application Publication
(10) Pub. No.: US 2014/0341386 A1
(43) Pub. Date: Nov. 20, 2014

(54) NOISE REDUCTION

(71) Applicant: ST-Ericsson SA, Plan-les-Ouates (FR)

(72) Inventor: LIONEL CIMAZ, Pleumeleuc (FR)

(21) Appl. No.: 14/283,023

(22) Filed: May 20, 2014

(30) Foreign Application Priority Data
May 20, 2013 (EP) 13168424

(51) Int. Cl. H04R 3/00

(52) U.S. Cl. CPC H04R 3/002
USPC 381/71.6

(57) ABSTRACT

An apparatus comprising a controller, a first acoustic sensor and a second acoustic sensor, wherein said first acoustic sensor is arranged remote from said second acoustic sensor, and wherein said controller is configured to receive a main signal from said first acoustic sensor, receive a probe signal from said second acoustic sensor, generate a noise signal by subtracting with a first filter filtered said main signal from said probe signal, and generate a noise reduced voice signal by subtracting with a second filter filtered noise signal from said main signal, wherein said first filter is adapted based on a voice component of the main signal and the probe signal in the absence or near absence of noise and said second filter is adapted based on the noise components of said main signal and said probe signal when no voice input is present.

### CROSS-REFERENCE TO RELATED APPLICATIONS

This application claims priority to and/or benefit of European Patent Application No. 13168424, filed May 20, 2013, entitled IMPROVED NOISE REDUCTION, the specification of which is incorporated by reference herein in its entirety.

### TECHNICAL FIELD

This application relates to a method and an apparatus for improved noise reduction, and in particular to a method and an apparatus such as a mobile communication terminal, for improved noise reduction by utilizing a second speaker.

### BACKGROUND

Audio quality of speech during a phone call is important for a good understanding of the conversation between one user and another user (end-to-end communication). To determine or measure the audio quality the Signal-to-Noise Ratio (SNR) is often used as a generic performance metric for the call (or audio) quality. Maximizing this performance metric enhances the speech quality.

During a voice call the signal is represented by the actual speech (voice) and the noise is not only the noise introduced by the communication interface, but also acoustic noise, such as surrounding or background sounds and noise.

The communication interface noise may be noise generated by the near-end or far-end terminals. Such noise may have a varying spectral shape, but is mainly constant during a call. It may also be introduced by the actual communication channel.

The acoustic noise may be static but also dynamic. The acoustic static noise may be picked up (or recorded) by electro-acoustic transducers, such as a microphone. For example, a rotating machine produces a regular acoustic noise which can be picked up by microphone of the mobile communication terminal. Unless the rotating machine changes its rotational speed, the spectrum of this noise will be constant.

The acoustic noise can also be dynamic noise that is picked up by electro-acoustic transducers. The dynamic acoustic noise may originate from street sounds, background speeches and background music to mention a few examples. These examples are particularly dynamic and the associated spectrum of such noise is dynamic and may change irregularly and unexpectantly.

It is possible to suppress stationary noise by using an algorithm implemented in the speech path which improves significantly the SNR (and the call quality) while the noise behaviour is static.

In the particular case of mobile communication terminals (a mobile phone for example), the noise environment cannot be restricted to a static class. A call can take place in the street, in a room with many people or with background music. Some specific means are needed on near-end side to transmit as little as possible of such dynamic noise in order to maximize or at least improve the speech quality.

Suppressing or handling dynamic noise at near-end (that is uplink) is complicated because the useful speech signal is in itself dynamic. Furthermore, some types of noise, such as background speech, have the same dynamics or characteristics as the speech intended to be transmitted so direct distinction is nearly impossible.

To enable suppression of uplink dynamic noise at the transmitting side many prior art systems use multiple acoustic microphones. These microphones are arranged to be spaced apart on the mobile communication terminal. Because no acoustic waves are purely plane in real field, the sound waves from acoustic sources far from the mobile communication terminal will hit different microphones with different phase/level than acoustic sources close to the mobile communication terminal. Based on these differences, it is possible to filter out signals which are not matching the phase/level difference of useful speech. The algorithms used for such filtering operation are often qualified as “beam former” because they are effectively giving preference for a specific acoustic beam axis.

To achieve a correct performance on dynamic noise suppression, existing solutions require the installing of at least two microphones on the mobile communication terminal and those microphones need to have a correct matching. These requirements increase the cost and the complexity of the mobile communication terminal. For example, an additional microphone has to be purchased and arranged on the mobile communication terminal (which increases the mechanical complexity). Also, the microphones need to match each other, thereby reducing the number of microphones available for selection.

There is thus a need for a low cost noise reduction that can be used in an apparatus, for example a mobile communication terminal, without increasing the mechanical complexity or the cost of the apparatus significantly.

### SUMMARY

It is an object of the teachings of this application to overcome or at least mitigate the problems listed above by reposing on the reversibility behaviour of a loudspeaker which can be used as a microphone. The concept enables the means to use this signal in order to provide an indirect second acoustic sensor for a dynamic noise reduction solution.

It is also an object of the teachings of this application to overcome the problems listed above by providing an apparatus comprising a controller, a first acoustic sensor and a second acoustic sensor, wherein said first acoustic sensor is arranged remote from said second acoustic sensor, and wherein said controller is configured to receive a main signal from said first acoustic sensor, receive a probe signal from said second acoustic sensor, generate a noise signal (N) by subtracting with a first filter (F) filtered said main signal from said probe signal, and generate a noise reduced voice signal (Vnr) by subtracting with a second filter (G) filtered noise signal (N) from said main signal, wherein said first filter is adapted based on a voice component of the main signal and the probe signal in the absence or near absence of noise and said second filter is adapted based on the noise components of said main signal and said probe signal when no voice input is present.

In one embodiment the apparatus is a sound recording device.

In one embodiment the apparatus is a mobile communication terminal.

It is also an object of the teachings of this application to overcome the problems listed above by providing a method for use in an apparatus comprising a first acoustic sensor and a second acoustic sensor, wherein said first acoustic sensor is arranged remote from said second acoustic sensor, said method comprising: receiving a main signal from said first acoustic sensor; receiving a probe signal from said second acoustic sensor; generating a noise signal (N) by subtracting with a first filter (F) filtered said main signal from said probe signal; and generating a noise reduced voice signal (Vnr) by subtracting with a second filter (G) filtered noise signal (N) from said main signal, wherein said first filter is adapted based on a voice component of the main signal and the probe signal in the absence or near absence of noise and said second filter is adapted based on the noise components of said main signal and said probe signal when no voice input is present.

The inventors of the present invention have realized, after inventive and insightful reasoning that by using the simple solution of using the loudspeaker (or other speaker) as a microphone the dynamic noise can he suppressed through an indirect measurement.

Furthermore, the inventors have devised a manner of matching two acoustic sensors, thereby also broadening the selection of possible microphones for an apparatus involving a plurality of acoustic sensors. This also finds use in apparatuses having a plurality of microphones (being acoustic sensors).

The proposed invention significantly decreases the mechanic complexity and cost of an apparatus, such as a mobile communication terminal, while achieving a good performance on uplink non-stationary noise suppression at near-end side.

The teachings herein find use in apparatuses where noise is a factor such as in mobile communication terminals and provides for a low cost noise reduction.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc.]” are to be interpreted openly as retelling to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention will be described in further detail under reference to the accompanying drawings in which:

FIGS. 1A and 1B each shows a schematic view of a mobile communication terminal according to one embodiment of the teachings of this application;

FIG. 2 shows a schematic view of the general structure of a mobile communication terminal according to one embodiment of the teachings of this application;

FIG. 3 shows a shows a schematic overview of the matching of a main signal and a probe signal according to one embodiment of the teachings of this application;

FIG. 4 shows a schematic overview of the voice activity detection according to one embodiment of the teachings of this application;

FIG. 5 shows a schematic view of the noise reduction scheme according to one embodiment of the teachings of this application; and

FIG. 6 shows a flowchart for a method according to one embodiment of the teachings of this application.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

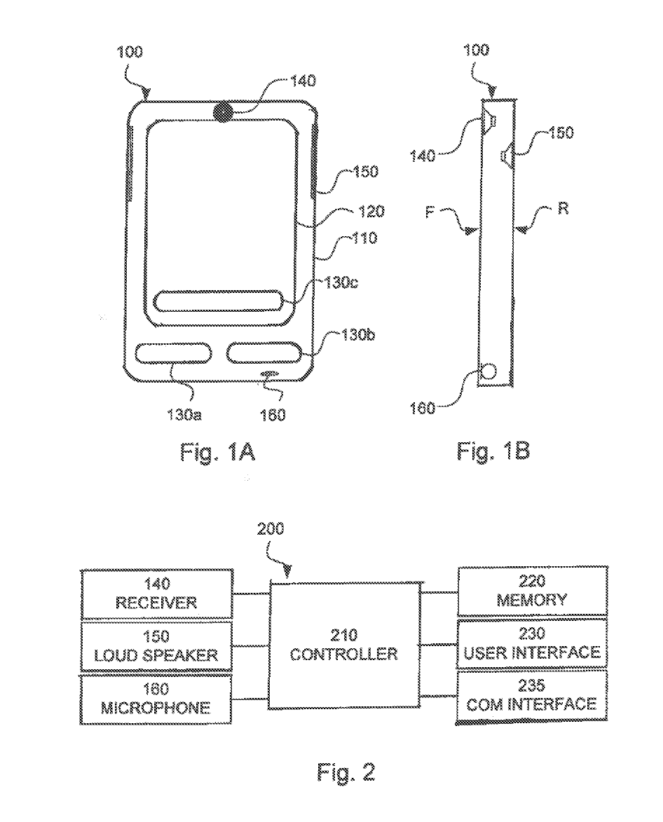

FIG. 1A shows a schematic overview of an apparatus 100 adapted according to the teachings herein. In the embodiment shown the apparatus is a mobile communications terminal which in this example is a mobile phone 100. In other embodiments the mobile communications terminal 100 is a personal digital assistant, or any hand-held device capable of recording sounds. The mobile phone 100 comprises a housing 110 in which a display 120 is arranged. In one embodiment the display 120 is a touch display. In other embodiments the display 120 is a non touch display. Furthermore, the mobile phone 100 comprises at least one key 130, virtual and/or physical. In the embodiment shown there are two physical keys 130a, 130b. In this embodiment there are two keys 130, but any number of keys, including none, is possible and depends on the design of the mobile phone 100. In one embodiment the mobile phone 100 is configured to display and operate a virtual key 130c on the touch display 120. It should be noted that the number of virtual keys 130c are dependent on the design of the mobile phone 100 and an application that is executed on the mobile phone 100.

The mobile communication terminal 100 is arranged with a microphone 160 for recording the speech of a user (and also possibly other sounds) and a first speaker 140, also referred to as a receiver 140, for example for providing the user with received voice communication. The mobile communication terminal 100 also comprises a second speaker 150, also referred to as a loud speaker 150, for providing audio to the surroundings of the mobile communication terminal 100 for example to play music or using the mobile communication terminal 100 in a speaker mode. In the example embodiment shown there are two loudspeakers for providing a stereo effect to a user.

It should be noted that in some sound recording apparati the first speaker may be optional or omitted. It should also be noted that the invention according to this application may also be utilized in a mobile communication terminal having only one speaker.

FIG. 1B shows a side view of a mobile communication terminal 100 such as the mobile communication terminal of FIG. 1A. It should be noted that the arrangement of the second speaker(s) 150 are different in the mobile communication terminal 100 of FIG. 1B compared to the arrangement of the mobile communication terminal 100 of FIG. 1A. Notably, there is only one loudspeaker in the mobile communication terminal 100 of FIG. 1B and it is placed on a rear side R of the mobile communication terminal 100. The microphone 160 is placed on a front side F of the mobile communication terminal 100 in both FIG. 1A and FIG. 1B.

FIG. 2 shows a schematic view of the general structure of a communications terminal according to FIG. 1. The mobile phone 100 comprises a controller 210 which is responsible for the overall operation of the mobile terminal and is preferably implemented by any commercially available CPU (“Central Processing Unit”), DSP (“digital signal processor”) or any other electronic programmable logic device or a combination of such processors or other electronic programmable logic device. The controller 210 may be implemented using instructions that enable hardware functionality, for example, by using executable computer program instructions in a general-purpose or special-purpose processor that may be stored on a computer readable storage medium (disk, memory etc) 220 to be executed by such a processor. The controller 210 is configured to read instructions from the memory 220 and execute these instructions to control the operation of the mobile communications terminal 100. The memory 220 may be implemented using any commonly known technology for computer-readable memories such as ROM, RAM, SRAM, DRAM, CMOS, FLASH, DDR, EEPROM memory, flash memory, hard drive, optical storage or any combination thereof The memory 220 is used for various purposes by the controller 210, one of them being for storing application data and various software modules in the mobile terminal.

The mobile communications terminal 200 may further comprise a user interface 230, which in the mobile communications terminal 100 of FIGS. 1A and 1B is comprised of the display 120, the keys 130, 135, the microphone 160, the receiver 140 and the loudspeaker 150. The user interface (UI) 230 also includes one or more hardware controllers, which together with the UI drivers cooperate with the display 120, keypad 130, as well as various other 110 devices such as microphone, loudspeaker, vibrator, ringtone generator, LED indicator, etc. As is commonly known, the user may operate the mobile terminal through the man-machine interface thus formed.

The mobile communications terminal 200 may further comprise a communication interface, such as a radio frequency interface 235, which is adapted to allow the mobile communications terminal to communicate with other communications terminals in a radio frequency band through the use of different radio frequency technologies. Examples of such technologies are W-CDMA, GSM, UTRAN, LTE and NMT to name a few.

Reducing the noise picked up by a microphone when the noise is dynamic requires at least a second acoustic sensor. Instead of using a second microphone as in prior art solutions, the concept uses the reversibility property of loudspeaker.

During speech call, when the mobile communication terminal 100 is used in handset operation, the loudspeaker 150 is inactive. A loudspeaker 150 is generally reversible, especially if it is implemented using a coil in combination with a magnet. It will generate sound based on a driving electrical signal, but if the electrical interface is not driven, the loudspeaker 150 will generate an electrical signal from the sound that hits its membrane. The loudspeaker 150 can thus be utilized as an acoustic sensor during a speech call in handset operation or when using a headset.

To enable a high quality operation the loudspeaker is arranged to be capable of high electrical driving signals when used as a loudspeaker for music or ringtones for example, while also have a high impedance when the loudspeaker 150 is used as an acoustic sensor. The driving circuit must have a high impedance during reverse operation and must also be capable of operating with high voltages generated when used as a loudspeaker. The loudspeaker may also be capable of operating at high frequencies, especially if the driving circuit is of class D.

The microphone 160 will thus provide a first sound path and the loudspeaker 150 will provide a second sound path. The two sound paths represent two different acoustic conversions in that the sensitivities of the two paths differ, the frequency magnitude responses differ and the phase responses also differ.

By tuning the gain of the two (or more) sound paths it is possible to align the sensitivity of the two sound paths.

However, because of the necessity to match the frequency magnitude response and the phase responses, beam forming prior art algorithms can not be used to suppress the dynamic noise successfully. A first step in matching the two sound paths is to convert the sound paths from analogue to digital using an analogue-to-digital (AD) converter.

To improve the matching of the two sound paths it is beneficial to align the two sound paths. This is achieved by at alignment filter.

To further improve the matching of the two sound paths it is also beneficial to limit the frequency content of the two paths to exclude frequency components in frequency bands that are not audible. This allows the matching to be performed on a reduced data set.

In one embodiment at least one of the sound paths is filtered in a low pass filter, a high pass filter or a bandpass filter to exclude frequency components that are not audible or that contribute to the audibility or understandability of the voice channel. In one embodiment at least one of the sound paths is filtered to exclude frequencies below 300 Hz. In one embodiment at least one of the sound paths is filtered to exclude frequencies above 3400 Hz.

The microphone 160 and the loudspeaker 150 are arranged to be spaced apart on the mobile communication terminal 100. As they are spaced apart the two sound signals that they receive (pick up) are different.

The first sound signal (picked up by the microphone 160), also called the main signal, comprises user voice and ambient noise signals, where the user voice is louder than the ambient noise (assuming normal operating conditions) as the microphone 160 is closer to the user's mouth than to the surrounding noise.

The second signal (Picked up by the loudspeaker 150), also called the probe signal, comprises user voice and ambient noise signals, where the user voice is not as loud as in the main signal as the loudspeaker 150 is closer to the surrounding noise than the user's mouth or, alternatively, the mobile communication terminal 100 may shield the loudspeaker 150 from sounds coming from the user's mouth. In any case, the user voice is louder in the main sound signal than in the probe due to the difference in distance from the acoustic sound sensor to the user's mouth.

During normal operating conditions with an even distribution of noise sources (“even distribution” may include at an even or similar distance to the two acoustic sensors) the ambient or surrounding noise represents a diffuse field and the ambient noise that is received by the microphone 160 is similar to the ambient noise received by the loudspeaker 150. From this it can be derived that the main signal has a higher ratio between the user's voice and the noise than the probe signal has.

We have:

main=voiceₘ+noiseₘ

probe=α.voiceₚ noiseₚ

With α<1, representing the lower voice level sensed by the loudspeaker 150 due to the larger distance to mouth.

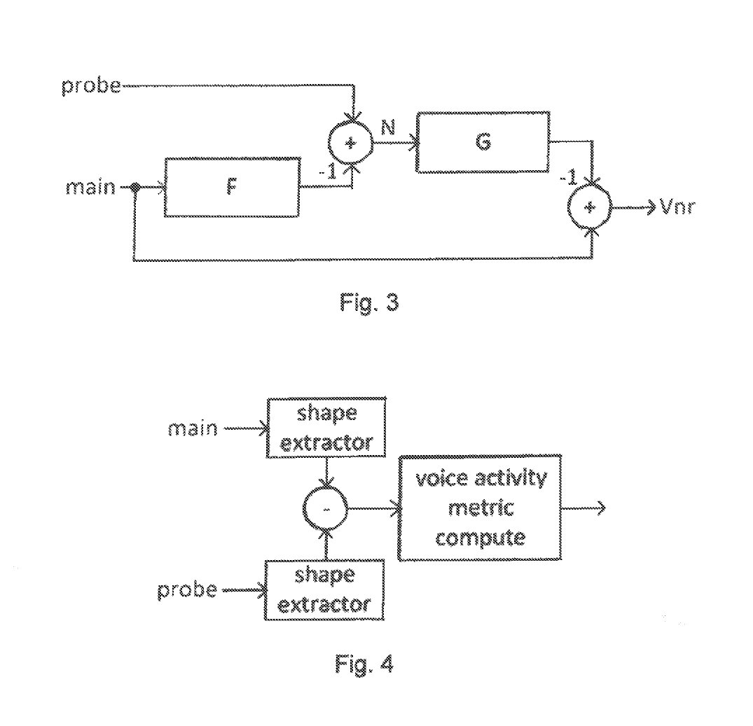

To achieve the matching two filters are employed. A first filter F is applied to the main signal and a second filter G is applied to the probe signal, see FIG. 3 which shows a schematic overview of the matching of a main signal and a probe signal.

As the first filter F is applied to the main signal we have:

F(main)=F(voiceₘ)+F(noiseₘ)

As can be seen in FIG. 4 the filtered main signal is subtracted from the probe signal:

N=probe−F(main)

N=α.voiceₚ+noiseₚ−F(voiceₘ)−F(noiseₘ)

N=α.voiceₚ−F(voiceₘ)+noiseₚ−F(noiseₘ)

In one embodiment the first filter F is arranged so that the filtered voice component of the main signal is roughly equal to the voice component (multiplied by α) of the probe signal, i.e.:

α.voiceₚ≅F(voiceₘ)

As the two voice components originate from the same sound source this can be achieved. Using such a first filter F we are able to determine a signal only comprising noise N. We get:

N= [symbol] − [symbol] +noiseₚ−F(noiseₘ)

N=noiseₚ−F(noiseₘ)

To determine the voice component of the main signal, the second filter G is applied to the noise signal N and the output from filter G is subtracted from the main signal (as in FIG. 4) to provide a signal Vnr with a reduced noise content. We get:

Vnr=main−Gout,

where

Gout=G(N)

Gout=G(noiseₚ−F(noiseₘ)),

which gives:

Vnr=voiceₘ+noiseₘ−G(noiseₚ−F(noiseₘ))

In one embodiment the second filter G is arranged so that the output of the second filter G is roughly equal to the noise component of the main signal, when the input is the difference between the noise component of the probe signal and the output of the first filter F of the noise component of the main signal. That is:

noiseₘ≅G(noiseₚ−F(noiseₘ))

As the noise components originate from the same noise source this is doable.

We get:

Vnr=voiceₘ + [symbol] −

[symbol]

[symbol]

Vnr=voiceₘ

The scheme of FIG. 3 thus extracts the voice component of the main signal by suppressing the noise components using a probe signal and applying a first filter F and a second filter G.

The mobile communication terminal 100 is configured to determine the second filter G by using an adaptation algorithm, such as a Least Mean Squares (LMS) algorithm or a Normalised Least Mean Squares (NLMS) algorithm or an adaptive NLMS algorithm based on minimizing the error between the noise component of the main signal and the G-filtered value of the difference between the noise component of the probe signal and the F-filtered value of the noise component of the main signal. We have:

Vnr=voiceₘ+noiseₘ−G(noiseₚ−F(noiseₘ))

The second filter G is dependent on the noise components and is thus best trained in the absence of any voice input. The mobile communication terminal 100 is therefore configured to detect when there is no voice input. In the absence of voice input we get:

Vnr=noiseₘ−G(noiseₚ−F(noiseₘ))

Vnr represents the error between the noise component of the main signal and the filtered value. By adapting G to minimize this error (close to 0) we get:

0≅noiseₘ−G(noiseₚ−F(noiseₘ))

noiseₘ≅G(noiseₚ−F(noiseₘ))

From this condition the second filter G can be trained using an adaptation algorithm s discussed above.

To train the second filter G according to the ambient noise it is helpful to determine when there is only ambient noise. It is therefore beneficial to be able to determine when a user is speaking and when he is not and the mobile communication terminal 100 is configured to detect voice activity and to determine when the user is speaking by employing a voice activation scheme.

One voice activation scheme is to use a slow time constant smoothing of the signal that is compared to a fast time constant smoothing of the same signal. Such voice activation detection works even when the noise level is louder than the voice level.

One alternative scheme is to determine the wave shapes of the signals or the signal components. This can be achieved by utilizing an envelope estimation technique such as peak detection in combination with a smoothed fall down filter. This identifies the dynamic characteristics of a signal and allows for detecting voice activation also in an environment with dynamic noise. Assuming that:

vad=main−probe

vad=voiceₘ+noiseₘ−α.voiceₚ−noiseₚ

We have:

shape(voiceₘ)≅shape(voiceₚ)

shape (noiseₘ)≅shape(noiseₚ)

vad=shape(main)−shape(probe)

vad=shape(voiceₘ)+ [symbol] −shape (α.voiceₚ)−

[symbol]

vad=(1−α).shape(voiceₘ)

The vad (voice activity detection) metric represents an estimation of a voice level. The activity metric can be determined from the voice level metric (vad). An activity measure can easily be calculated from the voice level in a number of manners.

In one embodiment the voice activation is determined from the voice level by extracting a Boolean data (1 or 0) by determining if the voice level exceeds a threshold level.

In one embodiment the voice activation is determined from the voice level by extracting a Boolean data (1 or 0) by determining a voice presence probability through gaining, scaling or clamping.

FIG. 4 shows a schematic view of the voice activity detection. A main signal (main) and a probe signal (probe) are passed through a shape extractor. The two shapes are subtracted and the voice activity metric is computed as per one of the embodiments described above.

The mobile communication terminal 100 is thus configured to determine the second filter G when there is no voice by employing a voice activation detection scheme as disclosed in the above.

The mobile communication terminal 100 is further configured to determine the first filter F based on the voice input that is the voice components of the main signal and of the probe signal. From above we can see that a noise signal N can be expressed as:

N=α.voiceₚ−F(voiceₘ)+noiseₚ−F(noiseₘ)

If there is no noise and only voice we get

N≅α.voiceₚ−F(voiceₘ)

Where N represents an error to adapt the first filter F on. As the noise is dynamic there will be periods of time when there is no noise present or at least when the noise level is much lower than the voice level. During such time windows it is possible to train the first filter F.

By using the voice activity detection and evaluating the magnitude on the probe signal it is possible to determine if the noise level is low enough to train the first filter F. By using the voice activity detection and evaluating the magnitude on the probe signal it is possible to determine if the noise level is low enough to train the first filter F. As F needs to converge during speech activity with low noise, a threshold on the vad metric expressed before can he a first condition to train the filter F. A second condition to meet at same time can be a threshold on the magnitude of the probe signal directly. In fact, the probe signal has a low quantity of speech so it can furnish a simple approximation of noise presence.

In addition, by arranging the loudspeaker 150 and the microphone 160 far apart the parameter α can be significantly low and if the first filter is close to full adaptation, the gain of filter F would also be low and close to the parameter α.

In one embodiment the mobile communication terminal 100 is configured to utilize an adaptation algorithm having a slow adaptation speed which enables to train the filter F even in the presence of noise. It should be noted that even if the first filter F is not yet fully trafined the adaptation of the second filter is still possible as it is only performed when there is no speech and the signal(s) only contain noise which will be suppressed efficiently.

In one embodiment the first filter F is a FIR (Finite Impulse Response) filter. In one embodiment the second filter G is a FIR (Finite Impulse Response) filter. FIR filters are useful even when a full adaptation is not possible and will thus provide a satisfactory noise reduction even before full training is achieved.

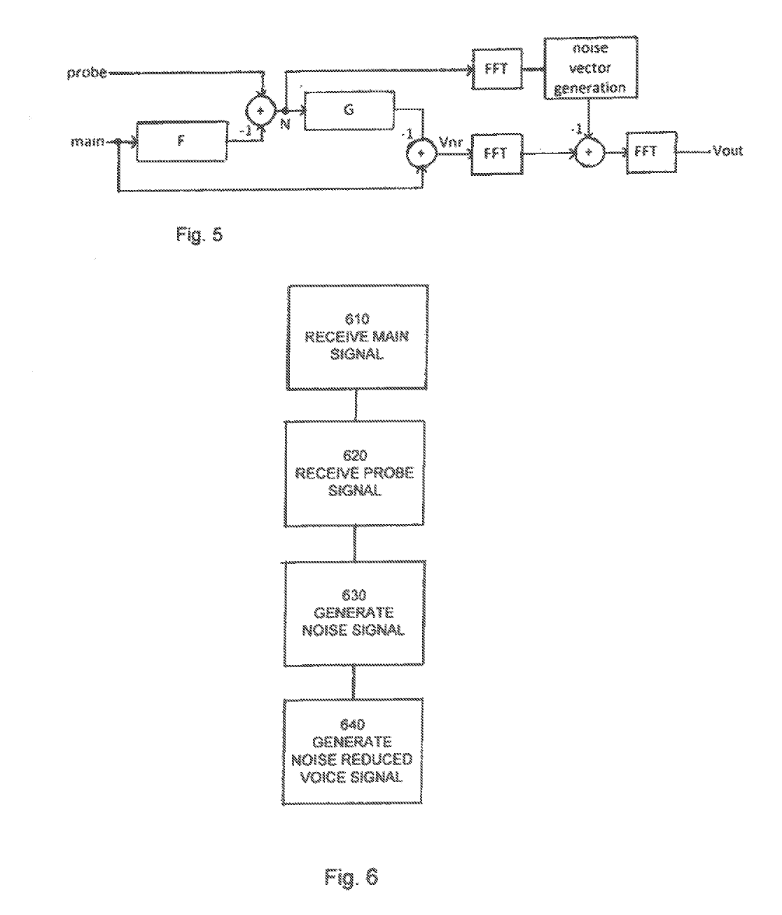

To further reduce the noise of the signal, the mobile communication terminal 100 is arranged to perform a spectral subtraction of the noise signal N from the voice signal Vnr. See FIG. 5 which shows a schematic view of the noise reduction scheme. Before the subtraction both the N signal and the Vnr signal transformed to their spectrums, through for example a Fast Fourier Transformation (FFT).

Also, the mobile communication terminal 100 may be configured to generate a noise vector that is subtracted from the voice signal Vnr. The mobile communication terminal 100 is further configured to generate the noise vector as an adaptive gain vector which is determined when there is no voice input controlled through the voice activation detection. This enables the noise reduction to work even when the noise N does not have a similar spectrum as the noise residue in Vnr and the gain vector is a good estimate of noise residue in the Vnr spectrum. The mobile communication terminal 100 may be configured to determine the gain vector through smoothing methods.

FIG. 6 shows a flowchart for a general method according to one embodiment of the teachings disclosed herein. A mobile communication terminal receives a main signal 610 from a first acoustic sensor 160 and receives a probe signal 620 from a second acoustic sensor 150. The mobile communication terminal 100 generates 630 a noise signal (N) by subtracting with a first filter (F) filtered said main signal from said probe signal. The mobile communication terminal 100 also generates a noise reduced voice signal 640 (Vnr) by subtracting with a second filter (G) filtered noise signal (N) from said main signal, wherein said first filter is adapted based on a voice component of the main signal and the probe signal in the absence or near absence of noise and said second filter is adapted based on the noise components of said main signal and said probe signal when no voice input is present.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate may or programmable logic device etc.

One benefit of the teachings herein is that the mobile communication terminal 100 provides good dynamic noise reduction without needing to implement a specific microphone for noise probing. The loudspeaker is simply reused as microphone. It is advantageous on cost perspective but moreover avoids mechanic complexity of placing a second microphone on small or dense phones. The manner or scheme itself is efficient on any kind of acoustic sensors without imposing the sources to be matched. This particularity is critical to operate with a speaker used in reverse operation but it remains interesting if a real microphone was used as probe sensor. In such case, the algorithm doesn't require any matching of main and probe microphones and probe microphone can be placed anywhere.

The algorithm can reduces non-stationary noise down to 0 whatever is noise wave direction. This is a significant advantage compared to beam forming approaches which doesn't offer noise attenuation if noise comes in same direction than user voice.

The invention has mainly been described above with reference to a few embodiments. However, as is readily appreciated by a person skilled in the art, other embodiments than the ones disclosed above are equally possible within the scope of the invention, as defined by the appended patent claims.

1. An apparatus comprising a controller, a first acoustic sensor and a second acoustic sensor each electrically connected to the controller, wherein the first acoustic sensor is arranged to the remote from the second acoustic sensor, and wherein the controller is configured to:
receive a main sound signal from the first acoustic sensor;
receive a probe sound signal from the second acoustic sensor;
filter the main sound signal with a first filter to produce a filtered main sound signal;
generate a noise signal by subtracting the filtered main sound signal from the probe sound signal;
filter the noise signal with a second filter to produce a filtered noise signal;
generate a reduced noise voice signal by subtracting the filtered noise signal from the main sound signal, wherein the first filter is configured based on a voice component of the main sound signal and a voice component of the probe sound signal when both signals have the absence or near absence of noise; and wherein the second filter is configured based on a noise component of the main sound signal and a noise component of the probe sound signal when both signals have no voice component.

2. The apparatus according to claim 1, wherein the controller is further configured to configure the second filter by using an adaptation algorithm such that the second filter minimizes an error between the noise component of the main sound signal and the filtered noise signal.

3. The apparatus according to claim 1, wherein the controller is further configured to detect whether a voice component is present in the main sound signal by performing a voice activity detection metric based on a shape of the voice component of the main sound signal, where the shape of voice component of the main sound signal is determined through an envelope estimation.

4. The apparatus according to claim 3, wherein the controller is further configured to determine that the voice activity detection metric indicates that the voice component is present when the voice activity detection metric exceeds a threshold level.

5. The apparatus according claim 3, wherein the controller is further configured to determine that the voice activity detection metric indicates that he voice component is present or not by calculating a voice presence probability through gaining, scaling or clamping.

6. The apparatus according to claim 1 wherein the controller is further configured to utilize an adaptation algorithm having a slow speed such that the first filter can be configured when noise is present in the main sound signal and the probe sound signal.

7. The apparatus according to claim 1, wherein the controller is further configured to perform a spectral subtraction of the noise signal from the reduced noise voice signal.

8. The apparatus according to claim 3, wherein the controller is further configured to perform a spectral subtraction of the noise signal from the reduced noise voice signal; and wherein the controller is further configured to generate a noise vector that is included as part of each of the main sound signal and the probe sound signal such that the noise factor is subtracted from the filtered noise signal, the noise factor is an adaptive gain vector that is determined when there is no voice component detected by the voice activity detection metric.

9. The apparatus according to claim 1, wherein the first acoustic sensor is arranged on a front side of the apparatus.

10. The apparatus according to claim 1, wherein the second acoustic sensor is arranged on a rear side of the apparatus.

11. The apparatus according to claim 1, wherein the first acoustic sensor is a microphone and second acoustic sensor is a speaker.

12. The apparatus according to claim 1, wherein the apparatus is a mobile communication terminal.

13. A method for canceling noise in the main sound signal received by the first acoustic sensor in a mobile communication terminal wherein the mobile communication terminal comprises a controller, the first acoustic sensor and a second acoustic sensor that is arranged to be remote from the first acoustic sensor; the method comprising:
receiving, by the controller, a main sound signal from the first acoustic sensor;
receiving, by the controller, a probe sound signal from the second acoustic sensor;
filtering, by a first filter, the main sound signal to provide a filtered main sound signal;
providing a noise signal by subtracting the filtered main sound signal from the probe sound signal;
filtering, by a second filter, the noise signal to provide a filtered noise signal;
generating a reduced noise voice signal by subtracting the filtered noise signal from the main sound signal;
wherein the first filter is configured to filter the main sound signal based on a voice component of the main sound signal and a voice component of the probe signal in the absence or near absence of a noise component; and
wherein the second filter is configured to filter the noise signal based on the noise components of the main sound signal and the noise components of the probe sound signal when no voice component is present.
